(19) United States
(12) Patent Application Publication
(10) Pub. No.: US 2026/0127786 A1
(43) Pub. Date: May 7, 2026

(54) AI-GENERATED MEDIA AFTER PLAY

(71) Applicant: Sony Interactive Entertainment Inc., Tokyo (JP)

(72) Inventor: Jeff Stafford, San Mateo, CA (US)

(21) Appl. No.: 18/938,079

(22) Filed: Nov. 5, 2024

(51) Int. Cl. G06T 11/60; A63F 13/67; G06F 40/166

(52) U.S. Cl. CPC G06T 11/60; A63F 13/67; G06F 40/166

(57) ABSTRACT

An artificial intelligence (AI) module captures gameplay to create personalized media including a child's storybook to motivate children to read based on their own game play, audio books and podcasts to listen to while commuting, memes/gifs to share online to friends, music while exercising, and screen saver highlight movies for work PCs to extend immersion and enjoyment of games after play.

### FIELD

The present application relates generally to AI-generated media after game play.

### BACKGROUND

With the increasing prevalence of computer games or video games, a great deal of user-centric data may be generated.

### SUMMARY

As understood herein, this user-centric data flowing from the user's play of computer games may be leveraged to provide further relevant audio video (AV) content for the user.

Accordingly, an apparatus includes at least one processor system configured to identify game play records generated from play of at least one computer game, and based at least in part on the game play records, to generate content.

In some embodiments the processor system can be configured to generate the content based at least in part on additional content in addition to the game play records.

In non-limiting examples the processor system may be configured to execute a first generative model to generate text based on the game play records, and execute a second generative model to generate the content based at least in part on the text generated by the first generative model.

In example implementations that content generated from the game play records can include one or more of a storybook with text and images, a podcast episode, an audio book, a meme, a gif, music, a highlight video.

In another aspect, an apparatus includes computer memory that is not a transitory signal and that in turn includes instructions executable by at least one processor system to execute at least a first generative model (GM) to generate a text summary of records of play of at least one computer game, and execute at least a second GM to generate content based at least in part on the text summary generated by the first GM.

In another aspect, a method includes receiving game play records representing records of computer game play, and generating content based on the game play records.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example system for generating content such as audio video (AV) content from game play records;

FIG. 3 illustrates example overall logic in example flow chart format;

FIG. 4 illustrates example logic in example flow chart format for generating a podcast from game play records;

FIG. 5 illustrates an example child's book generated from game play records;

FIG. 6 illustrates an example user interface (UI) for acquiring user preferences for generating content from game play records;

FIG. 7 illustrates example logic in example flow chart format for training a machine learning (ML) model such as a generative model such as a large language model (LLM) to generate summaries of game play records;

FIG. 8 illustrates example logic in example flow chart format for training an ML model such as a generative model such as an LLM to generate content from summaries of game play records;

FIG. 9 illustrates additional example logic in example flow chart format

FIG. 10 illustrates an example digital storybook; and

FIG. 11 illustrates an example hard copy storybook.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation^{®}or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

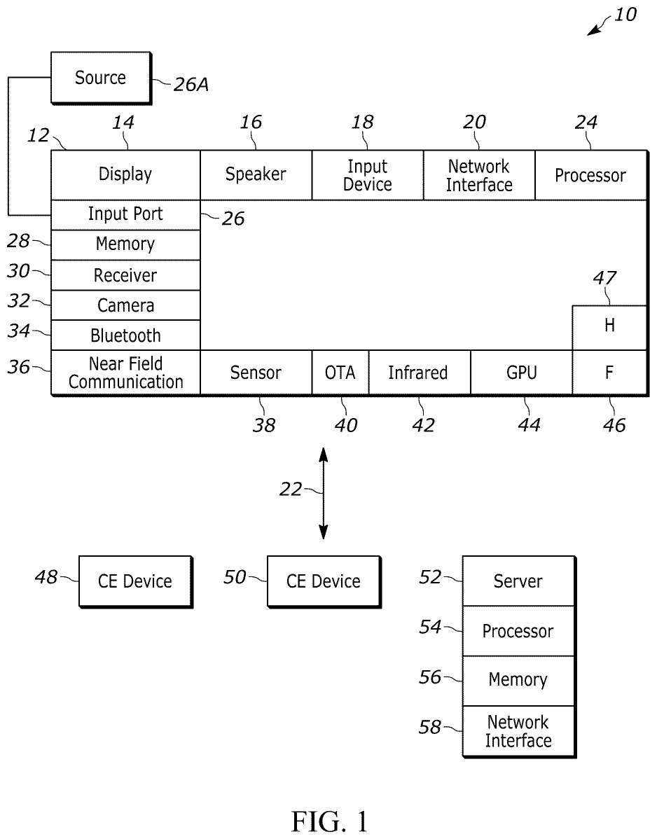

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

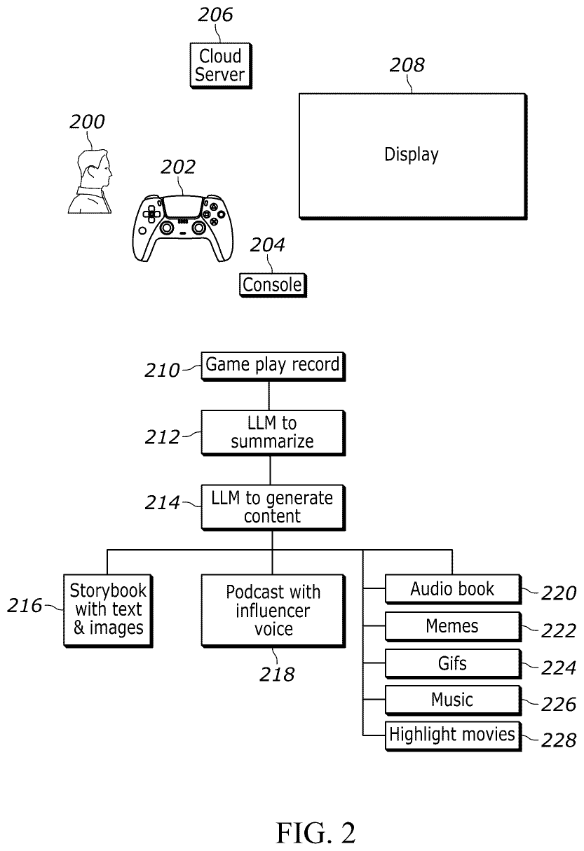

Refer now to FIG. 2. A user 200 such as a computer gamer can manipulate a computer game controller 202 to control play of a computer game sourced from a computer game console 204 and/or from a cloud server 206 for presentation in a display 208. The game is recorded to produce game play records 210. The game play records 210 may be sent to one or more ML models. In the example shown, a first LLM 212 summarizes the game play records in, e.g., text format, and a LLM 214 receives the summary and generated content based thereon.

An example of the content generated from the game play summary includes a storybook 216 with text and images. Another example of the content generated from the game play summary includes a podcast episode 218. Yet other examples of the content generated from the game play summary include audio books 220, memes 222, gifs 224, music 226, and highlight movies 228. The highlight movies 228 may be used as screen saver movies that may be automatically updated when the user logs on to his computer or mobile devices.

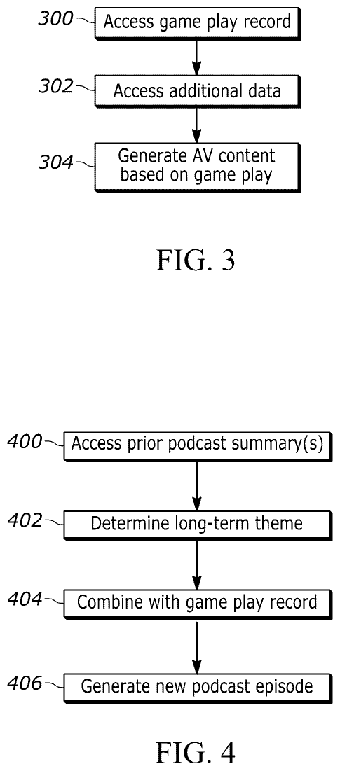

Now referring to FIG. 3, game play records are accessed at state 300. If desired, additional data may be accessed at state 302. Examples of additional data are discussed elsewhere herein. Proceeding to state 304, content is generated based on the game play records and, if used, on the additional data. The logic of FIG. 3 and other figures herein may be implemented by, e.g., the console 204 an/or cloud server 206.

FIG. 4 illustrates a first example of the above. Commencing at state 400, prior podcasts and/or summaries thereof, e.g., In text format, are accessed. A long term theme of the prior podcasts is determined at state 402. The theme is combined with the game play records at state 404 to generate a new podcast episode at state 406.

The episodic podcast content (which may be implemented as a social media short video sequence) can include a vocalized summary of the game play reflected in the game play records. The vocalized summary may echo the personality of an influencer who generated the prior podcast summaries accessed at state 400. Also, vocalized summary may be presented in the voice of the influencer and may use an image of the influencer as the speaker. Thus, the podcast episode generated at state 406 may be based not only on the game play records but also may be interwoven with prior episode data.

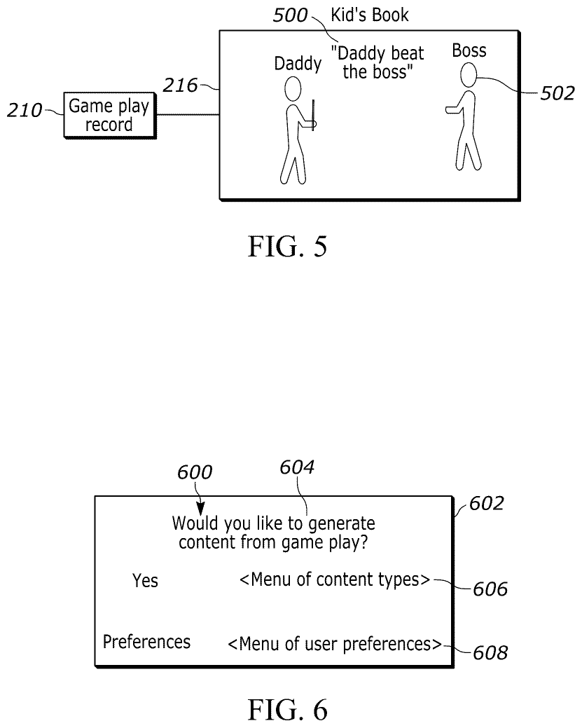

FIG. 5 illustrates an example child's book 216 generated from game play records 210 shown in FIG. 2. The book 216 may be generated in digital and/or hard copy form.

As shown, the book 216 can include text 500 describing a summary of the game play along with images 502 generated from the game play records. The images 502 may be generated from an image of the actual character in the game being referenced by the text 500, while images not present in the game records (such as “daddy” in FIG. 5) can be generated based on learning from photos, friends lists, gamer profiles, and other user data, or from generic iconography and stock photos and illustrations. If the book is to include audio (or be an entirely audio-based book), the voice used to narrate the game summary may be that of the non-game character (“daddy” in FIG. 5) or it may be the voice of a game character if desired. Additionally, the images and/or audio may be cartoon or stylized versions generated from the various sources mentioned.

FIG. 6 illustrates a user interface (UI) 600 that can be presented on a display 602 such as any display herein. The UI 600 includes a prompt 604 for the user to enter his or her preferences for content generation using game play records. These preferences may be used to establish the additional data from state 302 in FIG. 3.

If the user indicates a desire to enter preferences, a menu 606 such as a drop-down menu may be resented listing the types of content that may be generated from game play records, such as any of the content types shown in FIG. 2. Also, a menu 608 of user preferences from which the user may select can be presented. For example, the preferences on the menu 608 may include the length of play time of the selected content, what parts of the game to use such as boss kills, trophies,, etc., what mood (e.g., happy or sad events) the content should reflect, what game characters to focus on, and so on. Some of the user preferences may be based on automatic observation such as determining to focus on a particular scene in a game that the user dwelt on. Alternatively, the automatic preferences may be based on an additional UI for selecting who the generated content is for, including, but not limited to one or more family members, friends, co-workers or gaming rivals. This selection may also provide an age restriction to the generated content, for example, restricting generated material to content suitable for the age of the selected person. Depending on the type of content to be generated as selected by the user, game energy level, recorded user laughter, controller 202 motion, and screen shares to identify what might be interesting may also be used and/or presented for selection by the user. The user may select generating the content based on game play records from the perspective of the gamer, or of the opponent, or of a non-player character (NPC). The menu 608 further may enable the user to select whether to mix in current events as gleaned from, e.g., news feeds when generating the content based on game play records.

The user may select “surprise me” to allow the generative model freer rein in generating the content. Or, any of the above user selections may be implemented automatically by the game engine as additional data without the user specifically identifying the additional data. In addition to the game engine, the system of the game console 204 may automatically generate content. Therefore, the game developers, publishers and/or game platform provider may determine the types of generated content. For example, a game developer may periodically feature ‘NPC spotlights’, providing episodic content based on the computer gamer 200's interactions with the featured NPC. As another example, a publisher may want to generate content (podcasts, video shorts, etc.) as part of a promotional campaign in a lead up period to the release of a new version, sequel or new downloadable content (DLC) of a game. This promotional content could be tailored to computer gamer 200 based on their game play. As another example, a game platform provider may want to provide unique seasonal generated content across many game titles, tailored specifically by interactions of the players to each of the game titles. For instance, a game platform provider could generate Halloween Ghost Webtoons (A form of online storybook using cartoon style characterization) of all the funny scares the players encounter across a range of horror related game titles.

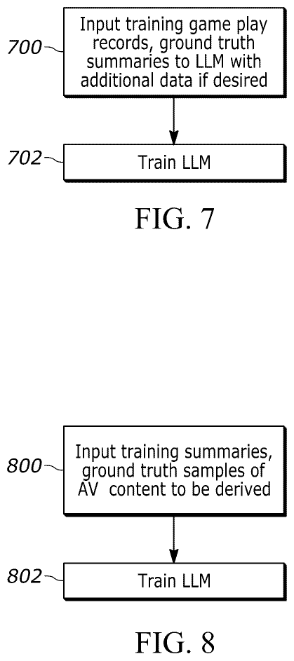

FIG. 7 illustrates a technique to train the ML model 212 in FIG. 2. Commencing at state 700, a training set of data is input to the ML model to train the model at state 702. The training set of data may include a set of training game play records (and, if desired, any of the additional data described herein to use in conjunction with the game play records) along with corresponding ground truth summaries of the game play records.

FIG. 8 illustrates a technique to train the ML model 214 in FIG. 2. Commencing at state 800, a training set of data is input to the ML model to train the model at state 802. The training set of data may include a set of text-based training summaries of game play records along with corresponding ground truth samples of content such as professionally created and curated AV content to be generated using the summaries. Note that a separate generative model may be trained for each type of content 216-228 shown in FIG. 2 or a single model may be trained to generate each of the content types.

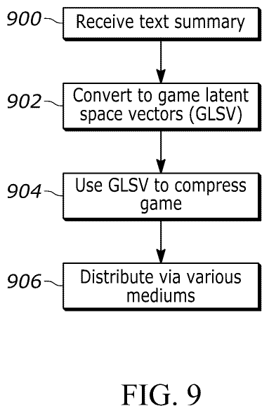

FIG. 9 provides a detailed example. Commencing at state 900, a generative model may receive a text-based summary of game play records. This model may be thought of as a game language model (GLM) that encompasses multiple models related to games, including a text-to-asset model that uses game textures, 3D modeling, sound effects, music tracks, and story text to produce text summaries of game assets in the game play records, a model that generates text based on game rules, a model that generates text based on game level layout, and a model that generates text based on game input configuration. These texts may be used as prompts to convert the text at state 902 to game latent space vectors (GLSV) that are essentially latent codes which may be embodied as a list of numerical codes, a list of floating point numbers or other types of codes representing a probability based instance of the game summary and it's associated data. State 904 indicates that the Latent Space Vectors (LSVs) represent a compressed version of the game play records to be distributed at state 906 via various media to a generative model such as the ML model 214 in FIG. 2 to generate content based on game play records.

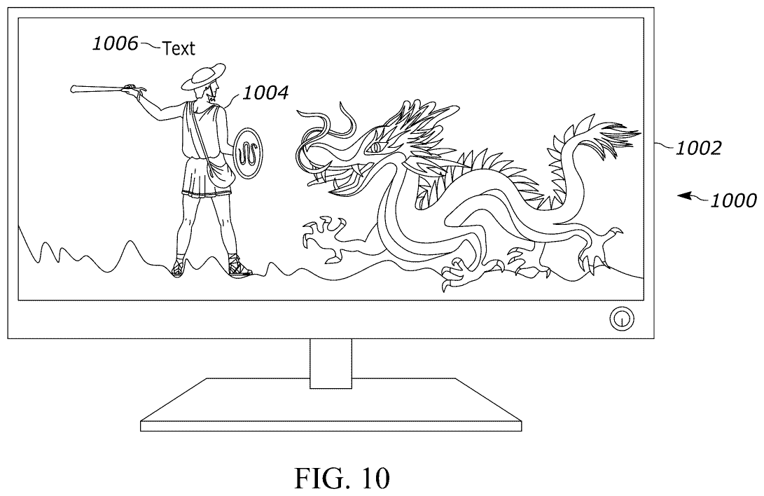

FIG. 10 illustrates a digital storybook 1000 presented on a display 1002 such as any display herein. The digital storybook includes illustration 1004 and text 1006.

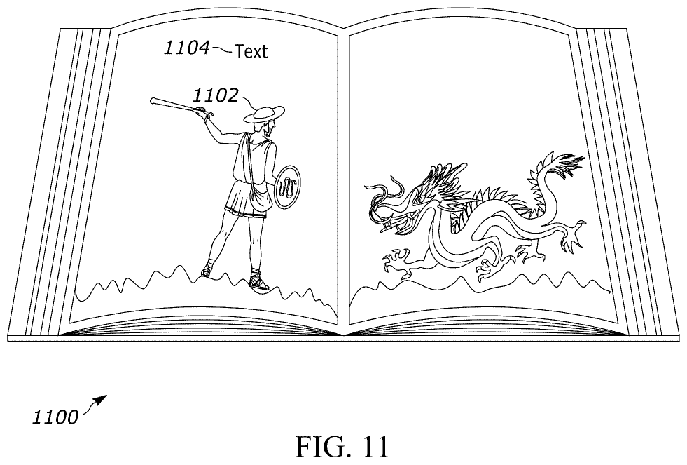

FIG. 11 illustrates a hard copy storybook 1100 on a paper substrate. The hard copy storybook includes illustration 1102 and text 1104.

While the particular embodiments are herein shown and described in detail, it is to be understood that the subject matter which is encompassed by the present invention is limited only by the claims.

What is claimed is:

1. An apparatus comprising:
at least one processor system configured to:
identify game play records generated from play of at least one computer game; and
based at least in part on the game play records, generate content.

2. The apparatus of claim 1, wherein the processor system is configured to:
generate the content based at least in part on additional content in addition to the game play records.

3. The apparatus of claim 1, wherein the processor system is configured to:
execute a first generative model to generate text based on the game play records; and
execute a second generative model to generate the content based at least in part on the text generated by the first generative model.

4. The apparatus of claim 1, wherein the content comprises a storybook with text and images.

5. The apparatus of claim 1, wherein the content comprises a podcast episode.

6. The apparatus of claim 1, wherein the content comprises an audio book.

7. The apparatus of claim 1, wherein the content comprises a meme.

8. The apparatus of claim 1, wherein the content comprises a gif.

9. The apparatus of claim 1, wherein the content comprises music.

10. The apparatus of claim 1, wherein the content comprises a highlight video.

11. An apparatus comprising:
computer memory that is not a transitory signal and that comprises instructions executable by at least one processor system to:
execute at least a first generative model (GM) to generate a text summary of records of play of at least one computer game; and
execute at least a second GM to generate content based at least in part on the text summary generated by the first GM.

12. The apparatus of claim 11, wherein the instructions are executable to:
generate the content based at least in part on additional content in addition to the records.

13. The apparatus of claim 11, wherein the content comprises a storybook with text and images.

14. The apparatus of claim 11, wherein the content comprises a podcast episode.

15. The apparatus of claim 11, wherein the content comprises an audio book.

16. The apparatus of claim 11, wherein the content comprises a meme.

17. The apparatus of claim 11, wherein the content comprises a gif.

18. The apparatus of claim 11, wherein the content comprises music.

19. The apparatus of claim 11, wherein the content comprises a highlight video.

20. A method, comprising:
receiving game play records representing records of computer game play; and
generating content based on the game play records.
